(19) United States
(12) Patent Application Publication
(10) Pub. No.: US 2015/0004401 A1
(43) Pub. Date: Jan. 1, 2015

(54) METHOD FOR FORMING MULTILAYERED COATING FILM

(71) Applicants: HONDA MOTOR CO., LTD., Tokyo (JP); Kansai Paint Co., Ltd., Hyogo (JP)

(72) Inventors: Keisuke Kojima, Saitama (JP); Takamasa Aoki, Saitama (JP); Takeshi Ogawa, Saitama (JP); Takao Egawa, Tochigi (JP); Shuji Okuda, Kanagawa (JP); Shuko Amiya, Kanagawa (JP); Takahiro Imai, Kanagawa (JP)

(21) Appl. No.: 14/381,014

(22) PCT Filed: Feb. 15, 2013
(86) PCT No.: PCT/JP2013/053658

§ 371 Date: Aug. 26, 2014

(30) Foreign Application Priority Data
Mar. 1, 2012 (JP) 2012-045609

(51) Int. Cl. B05D 7/00; C09D 175/04

(52) U.S. Cl. CPC B05D 7/572; C09D 175/04
USPC 428/334; 427/379; 524/507

(57) ABSTRACT

This invention provides a method for forming a multilayered coating film, which comprises applying a first aqueous base coating composition, then applying a second aqueous base coating composition without preheating, then conducting preheating, subsequently applying a clear coating composition, and then curing thus formed three layers of first aqueous base coating film, second aqueous base coating film and clear coating film simultaneously, wherein a coating composition which comprises a specific aqueous polyester resin, a specific aqueous acrylic resin, an aqueous urethane resin and a melamine resin, when used for the first aqueous base coating composition, gives a multilayered coating film which is excellent in smoothness, distinctness-of-image gloss, chipping resistance and hardness.

### TECHNOLOGICAL FIELD

This invention relates to a 3-coat-1-bake method for forming a multilayered coating film which is excellent in smoothness, distinctness-of-image gloss and chipping resistance, which method comprises coating a substrate with a first aqueous base coating composition, a second aqueous base coating composition and with a clear coating composition in order and heating and curing thus obtained three layers of multilayered coating film simultaneously, wherein preheating is conducted only once.

### BACKGROUND ART

By a widely employed method for forming a coating film on an automobile body, a substrate is coated with electrodeposition film and is then subjected to a 3-coat-2-bake system of “application of intermediate coating composition→baking and curing→application of base coating composition→application of clear coating composition→baking and curing”, and, thus, a multilayered coating film is formed.

From the viewpoint of energy saving, there has been considered these years a 3-coat-1-bake method of “application of intermediate coating composition→preheating→application of base coating composition→preheating→application of clear coating composition→baking and curing” in order, thereby omitting the baking and curing step after the application of intermediate coating composition. In particular, from the viewpoint of how to prevent environmental pollution due to the evaporation of organic solvent, there has been a strong demand for 3-coat-1-bake method wherein aqueous coating composition is used for the above-mentioned intermediate coating composition and base coating composition.

3-Coat-1-bake method wherein aqueous intermediate coating composition and aqueous base coating composition are used is, however, liable to cause layer mixture between the layers of first aqueous base coating composition and second aqueous base coating composition, and to thereby decrease smoothness and distinctness-of-image gloss of thus formed coating film.

Patent Document 1 discloses how to keep the above-mentioned layer mixture under control and thereby form a multilayered coating film having good appearance, by using, in a 3-coat-1-bake method, an aqueous intermediate coating composition which contains an aqueous dispersion of specific acrylic resin particles which dispersion is obtained from the emulsion polymerization of amide group-containing ethylenically unsaturated monomer and other ethylenically unsaturated monomer.

With a view to further accelerating energy saving, there has recently been considered a non-intermediate coating method wherein a substrate is coated with electrodeposition film and is then subjected to “application of base coating composition→application of clear coating composition→baking and curing”, thus omitting the application of intermediate coating composition.

Generally, electrodeposition film has good corrosion resistance, intermediate coating film is excellent in smoothness and chipping resistance, and base coating film and clear coating film have good appearance. Hence, a multilayered coating film made of layers of these coating films provides a substrate with good corrosion resistance, smoothness, chipping resistance, and good appearance.

The above-mentioned non-intermediate coating method cannot provide an intermediate coating film which is excellent in smoothness and chipping resistance, and, so, thus obtained multilayered coating film is inferior in smoothness and chipping resistance.

Patent Document 2 discloses a non-intermediate coating method to form a multilayered coating film with chipping resistance or the like maintained and also with an appearance improved, which method uses an aqueous base coating composition which comprises a specific core/shell type acrylic resin emulsion, a specific polyether polyol and an active methylene type blocked polyisocyanate.

### CITATION LIST

### Patent Literature Documents

Patent Document 1: Japanese Patent Application KOKAI Publication No. 2001-205175
Patent Document 2: Japanese Patent Application KOKAI Publication No. 2010-253383

### SUMMARY OF INVENTION

### Technical Problem

In the method of Patent Document 1 for forming a multilayered coating film, it is difficult to omit preheating after the application of intermediate coating composition. In the method of Patent Document 2 for forming a multilayered coating film, on the other hand, it may be sometimes difficult to give a multilayered coating film with sufficient smoothness, distinctness-of-image gloss and chipping resistance.

The objective of this invention is to provide a method (hereinafter sometimes referred to as “aqueous 1-preheating-3C-1B process) for forming a multilayered coating film which is excellent in smoothness, distinctness-of-image gloss, chipping resistance and hardness, which method comprises applying a first aqueous base coating composition, then applying a second aqueous base coating composition without preheating, then conducting preheating, and subsequently applying a clear coating composition, and then curing thus formed three layers of first aqueous base coating film, second aqueous base coating film and clear coating film simultaneously.

### Solution to Problem

The inventors of this invention have seriously considered how to achieve the above-mentioned objective, and have now found out that, in an aqueous 1-preheating-3C-1B process for forming a multilayered coating film, a coating composition which comprises a specific aqueous polyester resin, a specific aqueous acrylic resin, an aqueous urethane resin and a melamine resin, when used for the first aqueous base coating composition, gives a multilayered coating film which is excellent in smoothness, distinctness-of-image gloss, chipping resistance and hardness. The inventors of this invention has thus completed this invention.

This invention provides a method for forming a multilayered coating film which comprises:

(1) a step of coating a cured electrodeposition coating film with a first aqueous base coating composition (A) to form a first base coating film with a thickness of cured film of 20-35 μm;
(2) a step of coating the first base coating film with a second aqueous base coating composition (B) without preheating, to form a second base coating film with a thickness of cured film of 8-18 μm;
(3) a step of conducting preheating and thereafter coating the second base coating film with a clear coating composition (C) to form a clear coating film with a thickness of cured film of 25-50 μm; and
(4) a step of heating and curing the first base coating film, the second base coating film and the clear coating film simultaneously to form a cured coating film,
wherein the first aqueous base coating composition (A) comprises 15-35 parts by mass of an aqueous polyester resin (a), 15-30 parts by mass of an aqueous acrylic resin (b), 15-30 parts by mass of an aqueous urethane resin (c) and 15-35 parts by mass of a melamine resin (d), based on 100 parts by mass of the total solid content of these resins,
wherein aqueous polyester resin (a) is made of a polybasic acid component which comprises 55-75 mole % of aromatic ring- and/or alicyclic ring-containing polybasic acid based on the total amount of polybasic acid, aqueous polyester resin (a) having an acid value of 15-25 mgKOH/g and a number average molecular weight of 1000-5000, and
wherein aqueous acrylic resin (b) is an acrylic emulsion which is obtained from the emulsion polymerization of a monomer component which comprises 45-80% by mass of polymerizable unsaturated monomer having alkyl group of four to eight carbon atoms, 1-10% by mass of hydroxyl group-containing polymerizable unsaturated monomer, 1-10% by mass of carboxyl group-containing polymerizable unsaturated monomer and 0-53% by mass of other polymerizable unsaturated monomer, based on the total mass of monomers.

### Advantageous Effects of Invention

Owing to the specific aqueous 1-preheating-3C-1B process, the method of this invention for forming a multilayered coating film gives a multilayered coating film which is excellent in smoothness, distinctness-of-image gloss, chipping resistance and hardness.

In the following, the method of this invention for forming a multilayered coating film is explained in more detail.

### DESCRIPTION OF EMBODIMENTS

In the method of this invention for forming a multilayered coating film, a substrate like steel plate is firstly coated with electrodeposition coating composition, which is then heated and cured to give a cured electrodeposition coating film.

The above-mentioned steel plate includes those for automobile body, such as alloyed hot-dip galvanized steel plate, hot-dip galvanized steel plate, electrolytic zinc-coated steel plate, cold-rolled steel plate, etc. Said steel plates may be those which have undergone a phosphate treatment, a chromate treatment or a complex oxide treatment, on their surface.

For the above-mentioned electrodeposition coating composition, any known ones (e.g., those mentioned in Japanese Patent Application KOKAI Publication No. 2003-306796 etc.) may be used. In particular preferable is cationic electrodeposition coating composition.

Step (1):

The above-mentioned cured electrodeposition coating film is coated with a first aqueous base coating composition (A) to form a first base coating film with a thickness of cured film of 20-35 μm.

First Aqueous Base Coating Composition (A)

First aqueous base coating composition (A) is an aqueous coating composition which comprises an aqueous polyester resin (a), an aqueous acrylic resin (b), an aqueous urethane resin (c) and a melamine resin (d), resin (a) accounting for 15-35 parts by mass, resin (b) accounting for 15-30 parts by mass, resin (c) accounting for 15-30 parts by mass, and resin (d) accounting for 15-35 parts by mass, based on 100 parts by mass of the total solid content of these resins.

Aqueous Polyester Resin (a)

Aqueous polyester resin (a) is a polyester resin which is made of a polybasic acid component which comprises 55-75 mole % of aromatic ring- and/or alicyclic ring-containing polybasic acid based on the total amount of polybasic acid component, aqueous polyester resin (a) having an acid value of 15-25 mgKOH/g and a number average molecular weight of 1000-5000.

Aqueous polyester resin (a) can normally be obtained from the esterification or transesterification of polybasic acid component (a-1) and alcohol component (a-2) which are mentioned below.

Polybasic Acid Component (a-1)

In order that layer mixture between the first aqueous base coating composition (A) and the second aqueous base coating composition (B) which is mentioned later may be kept under control and that a multilayered coating film may be formed with excellent smoothness, distinctness-of-image gloss, chipping resistance and hardness, polybasic acid component (a-1) should comprise aromatic ring-containing polybasic acid (a-1-1) (hereinafter referred to as “aromatic polybasic acid”) and/or alicyclic ring-containing polybasic acid (a-1-2) (hereinafter referred to as “alicyclic polybasic acid”). The total amount of aromatic polybasic acid (a-1-1) and alicyclic polybasic acid (a-1-2) in polybasic acid component (a-1) generally accounts for 55-75 mole %, especially 60-70 mole %, based on the total amount of polybasic acid component (a-1).

Aromatic polybasic acid (a-1-1) generally includes aromatic compound having two, preferably two or three, carboxylic groups in a molecule, acid anhydride of said aromatic compound, compound produced by the esterification of said aromatic compound, etc., examples of which are aromatic polyvalent carboxylic acid such as phthalic acid, isophthalic acid, terephthalic acid, naphthalenedicarboxylic acid, biphenyl-4,4′-dicarboxylic acid, trimellitic acid, pyromellitic acid; anhydride of said aromatic polyvalent carboxylic acid; lower alkyl compound produced by the esterification of said aromatic polyvalent carboxylic acid, etc. Aromatic polybasic acid (a-1-1) may be used singly or in combination of two or more species. Phthalic acid, phthalic anhydride, isophthalic acid, trimellitic acid and trimellitic anhydride are in particular desirable from the viewpoint of the distinctness-of-image gloss, chipping resistance, etc., of thus obtained multilayered coating film.

Alicyclic polybasic acid (a-1-2) generally includes compound having at least one alicyclic structure (mainly 4- to 6-membered structure) and at least two, preferably two or three, carboxylic groups in a molecule, acid anhydride of said compound, compound produced by the esterification of said compound, etc., examples of which are alicyclic polyvalent carboxylic acid such as 1,2-cyclohexanedicarboxylic acid, 1,3-cyclohexanedicarboxylic acid, 1,4-cyclohexanedicarboxylic acid, cyclohex-4-ene-1,2-dicarboxylic acid, 3-methylcyclohexane-1,2-dicarboxylic acid, 4-methylcyclohexane-1,2-dicarboxylic acid, 1,2,4-cyclohexanetricarboxylic acid, and 1,3,5-cyclohexanetricarboxylic acid; anhydride of said alicyclic polyvalent carboxylic acid; lower alkyl compound produced by the esterification of said alicyclic polyvalent carboxylic acid, etc. Alicyclic polybasic acid (a-1-2) as mentioned above may be used singly or in combination of two or more species. 1,2-Cyclohexanedicarboxylic acid, 1,2-cyclohexanedicarboxylic anhydride, 1,3-cyclohexanedicarboxylic acid, 1,4-cyclohexanedicarboxylic acid, cyclohex-4-ene-1,2-dicarboxylic acid, cyclohex-4-ene-1,2-dicarboxylic anhydride are in particular desirable from the viewpoint of the distinctness-of-image gloss, chipping resistance, etc., of thus obtained multilayered coating film.

In this description, the term “lower” means that an organic group with this term has at most six, preferably at most four, carbon atoms.

From the viewpoint of chipping resistance of thus obtained multilayered coating film, it is desirable to use alicyclic polybasic acid (a-1-2) singly, or to use aromatic polybasic acid (a-1-1) and alicyclic polybasic acid (a-1-2) in combination. The molar ratio of aromatic polybasic acid (a-1-1) to alicyclic polybasic acid (a-1-2) desirably falls within the range generally of from 90/10 to 0/100, preferably of from 50/50 to 0/100, especially of from 35/65 to 0/100.

For polybasic acid component (a-1), other polybasic acid component may be used in addition to the above-mentioned aromatic polybasic acid (a-1-1) and alicyclic polybasic acid (a-1-2). In particular, aliphatic polybasic acid (a-1-3) may be suitably employed.

Aliphatic polybasic acid (a-1-3) generally includes aliphatic compound having at least two, preferably two, carboxylic groups in a molecule, acid anhydride of said aliphatic compound, compound produced by the esterification of said aliphatic compound, etc., examples of which are aliphatic polyvalent carboxylic acid such as succinic acid, glutaric acid, adipic acid, pimelic acid, suberic acid, azelaic acid, sebacic acid, undecanedioic acid, dodecanedioic acid, brasylic acid, octadecanedioic acid, citric acid, etc.; anhydride of said aliphatic polyvalent carboxylic acid; lower alkyl compound produced by the esterification of said aliphatic polyvalent carboxylic acid, etc. Aliphatic polybasic acid as mentioned above may be used singly or in combination of two or more species. Adipic acid is in particular desirable from the viewpoint of the smoothness etc., of thus obtained multilayered coating film.

Other polybasic acid component than aromatic polybasic acid (a-1-1), alicyclic polybasic acid (a-1-2) and aliphatic polybasic acid (a-1-3) includes fatty acid such as palm oil fatty acid, cottonseed oil fatty acid, hempseed oil fatty acid, rice bran oil fatty acid, fish oil fatty acid, tall oil fatty acid, soybean oil fatty acid, flaxseed oil fatty acid, tung oil fatty acid, rapeseed oil fatty acid, castor oil fatty acid, dehydrated castor oil fatty acid, safflower oil fatty acid, etc.; monocarboxylic acid such as lauric acid, myristic acid, palmitic acid, stearic acid, oleic acid, linoleic acid, linolenic acid, benzoic acid, p-tert-butylbenzoic acid, cyclohexanoic acid, 10-phenyl octadecanoic acid, etc.; hydroxy carboxylic acid such as lactic acid, 3-hydroxybutyric acid, 3-hydroxy-4-ethoxybenzoic acid, etc. The above-mentioned other polybasic acid components may be used either singly or in combination of two or more species.

Aromatic polybasic acid (a-1-1) and alicyclic polybasic acid (a-1-2) may be used in an amount ranging from 55-75 mole % in total, especially 60-70 mole % in total, based on the total amount of polybasic acid component.

Alcohol Component (a-2)

For alcohol component (a-2), polyhydric alcohol having at least two, preferably two or three, hydroxyl groups in a molecule may be suitably employed. Said polyhydric alcohol includes dihydric alcohol such as ethylene glycol, propylene glycol, diethylene glycol, trimethylene glycol, tetraethylene glycol, triethylene glycol, dipropylene glycol, 1,4-butanediol, 1,3-butanediol, 2,3-butanediol, 1,2-butanediol, 3-methyl-1,2-butanediol, 2-butyl-2-ethyl-1,3-propanediol, 1,2-pentanediol, 1,5-pentanediol, 1,4-pentanediol, 2,4-pentanediol, 2,3-dimethyltrimethylene glycol, tetramethylene glycol, 3-methyl-4,3-pentanediol, 3-methyl-1,5-pentanediol, 2,2,4-trimethyl-1,3-pentanediol, 1,6-hexanediol, 1,5-hexanediol, 1,4-hexanediol, 2,5-hexanediol, neopentyl glycol, 1,4-cyclohexane dimethanol, tricyclodecane dimethanol, hydrogenated bisphenol A, hydrogenated bisphenol F; polylactone diol which is prepared by the addition of lactone like ε-caprolactone to dihydric alcohol as mentioned above; esterdiols such as bis(hydroxyethyl)terephthalate; polyether diols such as alkylene oxide-addition product of bisphenol A, polyethylene glycol, polypropylene glycol, polybutylene glycol; trihydric or higher hydric alcohol such as glycerin, trimethylol ethane, trimethylol propane, diglycerin, triglycerin, 1,2,6-hexane triol, pentaerythritol, dipentaerythritol, sorbitol, mannite, etc.; and polylactone polyol which is prepared by the addition of lactone like ε-caprolactone to trihydric or higher hydric alcohol as mentioned above.

For alcohol component (a-2), other alcohol component may be used in addition to the above-mentioned polyhydric alcohol. Said other alcohol component includes monoalcohol such as methanol, ethanol, propyl alcohol, butyl alcohol, stearyl alcohol and 2-phenoxy ethanol; alcohol compound which is prepared by reaction between acid and monoepoxy compound such as propylene oxide, butylene oxide and glycidyl ester of synthetic hyperbranched saturated aliphatic acid (“Cardura E 10” as a trademark; manufactured by Hexion Specialty Chemicals). Alcohol component (a-2) may be used singly or in combination of two or more species. Neopentyl glycol and trimethylol propane are in particular desirable from the viewpoint of the smoothness, chipping resistance, etc., of thus obtained multilayered coating film.

Aqueous polyester resin (a) may be manufactured by any usual method for the production of polyester resin; there is no special limitation on the method. For example, polybasic acid component (a-1) and alcohol component (a-2) may be made to react with each other in an atmosphere of inert gas, e.g., in nitrogen gas flow, at a temperature of about 150 to about 250° C. for 5 to 10 hours, to be thereby subjected to esterification or transesterification.

For the above-mentioned esterification or transesterification, polybasic acid component (a-1) and alcohol component (a-2) may be added either at a time or divided into several batches and added separately. Furthermore, it would be acceptable to first synthesize carboxyl group-containing polyester resin and then esterify at least a part of carboxyl group in said carboxyl group-containing polyester resin with alcohol component (a-2). Also acceptable is to first synthesize hydroxyl group-containing polyester resin and then make the same react with acid anhydride to thereby half esterify said hydroxyl group-containing polyester resin.

In the above-mentioned esterification or transesterification, catalyst may be used to accelerate the reaction. Said catalyst includes known ones such as dibutyltin oxide, antimony trioxide, zinc acetate, manganese acetate, cobalt acetate, calcium acetate, lead acetate, tetrabutyl titanate and tetraisopropyl titanate.

Aqueous polyester resin (a) may be modified with aliphatic acid, monoepoxy compound, polyisocyanate compound, etc., either during the preparation of said resin or after esterification or transesterification of the same.

The above-mentioned aliphatic acid includes palm oil fatty acid, cottonseed oil fatty acid, hempseed oil fatty acid, rice bran oil fatty acid, fish oil fatty acid, tall oil fatty acid, soybean oil fatty acid, flaxseed oil fatty acid, tung oil fatty acid, rapeseed oil fatty acid, castor oil fatty acid, dehydrated castor oil fatty acid, safflower oil fatty acid, etc.

For the above-mentioned monoepoxy compound, glycidyl ester of synthetic hyperbranched saturated aliphatic acid (“Cardura E 10” as a trademark; manufactured by Hexion Specialty Chemicals) may be suitably employed.

The above-mentioned polyisocyanate compound includes organic polyisocyanate per se like aliphatic diisocyanate such as lysine diisocyanate, hexamethylene diisocyanate, trimethylhexane diisocyanate, etc.; alicyclic diisocyanate such as hydrogenated xylene diisocyanate, isophorone diisocyanate, methylcyclohexane-2,4-diisocyanate, methylcyclohexane-2,6-diisocyanate, 4,4′-methylenebis(cyclohexylisocyanate), 1,3-(isocyanatomethyl)cyclohexane, etc.; aromatic diisocyanate such as tolylene diisocyanate, xylylene diisocyanate, diphenylmethane diisocyanate, etc.; trivalent or higher valence polyisocyanate such as lysine triisocyanate, or addition product of each of said organic polyisocyanates with polyhydric alcohol, low molecular polyester resin or with water etc., or product of cyclization polymerization of the above-mentioned organic diisocyanates with each other (e.g., isocyanurate), or biuret type adduct of the above-mentioned organic diisocyanates, etc. These may be used either singly or in combination of two or more species.

From the viewpoint of the water resistance, hardness, etc., of the obtained multilayered coating film, aqueous polyester resin (a) desirably has a hydroxyl value generally in the range of 60-200 mgKOH/g, in particular of 80-180 mgKOH/g, especially of 100-150 mgKOH/g.

From the viewpoint of the water resistance, distinctness-of-image gloss, etc., of the obtained multilayered coating film, aqueous polyester resin (a) desirably has an acid value generally in the range of 15-25 mgKOH/g, in particular of 18-23 mgKOH/g, especially of 19-22 mgKOH/g.

The acid value and the hydroxyl value of aqueous polyester resin (a) can be adjusted, for example by the adjustment of the proportion of polybasic acid component (a-1) and alcohol component (a-2) blended, or by the adjustment of reaction temperature or reaction time of the above-mentioned esterification or transesterification.

Further from the viewpoint of the smoothness, distinctness-of-image gloss, chipping resistance, hardness, etc., of thus obtained multilayered coating film, aqueous polyester resin (a) desirably has a number average molecular weight generally in the range of 1000-5000, in particular of 1200-4000, especially of 1250-3000.

The number average molecular weight of aqueous polyester resin (a) can be adjusted, for example by the adjustment of reaction temperature or reaction time of the above-mentioned esterification or transesterification.

In this description, the number average molecular weight and the weight average molecular weight were found by measuring number average molecular weight and weight average molecular weight by Gel Permeation Chromatography (GPC) and then converting the measurement values on the basis of the molecular weight of standard polystyrene, specifically under the condition of mobile phase of tetrahydrofuran, measurement temperature of 40° C., and of flow rate of 1 mL/min, with RI as a detector, “HLC-8120 GPC” (trademark; manufactured by Tosoh Corporation) as an apparatus for Gel Permeation Chromatography, and with the four of “TSKgel G4000HXL”, “TSKgel G3000HXL”, “TSKgel G2500HXL” and “TSKgel G2000HXL” (trademarks; each manufactured by Tosoh Corporation) as column. For standard polystyrene, those on the market such as “TSK Standard Polystyrene” (manufactured by Tosoh Corporation) are usable.

Aqueous polyester resin (a) can be made water soluble or water dispersible if carboxyl group in the molecule is neutralized with basic compound. Said basic compound includes hydroxide of alkali metal or alkaline earth metal such as sodium hydroxide, potassium hydroxide, lithium hydroxide, calcium hydroxide, barium hydroxide, etc.; ammonia; primary monoamine such as ethyl amine, propyl amine, butyl amine, benzyl amine, monoethanol amine, neopentanol amine, 2-aminopropanol, 2-amino-2-methyl-1-propanol, 3-aminopropanol, etc.; secondary monoamine such as diethyl amine, diethanol amine, di-n-propanol amine, di-iso-propanol amine, N-methylethanol amine, N-ethylethanol amine, etc.; tertiary monoamine such as dimethylethanol amine, trimethyl amine, triethyl amine, triisopropyl amine, methyl diethanol amine, 2-(dimethylamino)ethanol, etc.; and polyamine such as diethyhlene triamine, hydroxyethyl aminoethyl amine, ethyl aminoethyl amine, methylaminopropyl amine.

From the viewpoint of the water resistance etc., of the obtained multilayered coating film, the above-mentioned basic compound is desirably used in an amount normally in the range of from about 0.1 to about 1.5 equivalents, preferably from about 0.2 to about 1.2 equivalents, based on the acid group of aqueous polyester resin (a).

Aqueous Acrylic Resin (b)

For aqueous acrylic resin (b), there should be employed an acrylic emulsion which is obtained from the emulsion polymerization of a monomer component which comprises 45-80% by mass of polymerizable unsaturated monomer (b-1) having alkyl group of four to eight carbon atoms, 1-10% by mass of hydroxyl group-containing polymerizable unsaturated monomer (b-2), 1-10% by mass of carboxyl group-containing polymerizable unsaturated monomer (b-3) and 0-53% by mass of other polymerizable unsaturated monomer (b-4), based on the total mass of the monomers, in order that layer mixture between the first aqueous base coating composition (A) and the second aqueous base coating composition (B) which is mentioned later may be kept under control and that a multilayered coating film may be formed with excellent smoothness, distinctness-of-image gloss, chipping resistance and hardness.

For polymerizable unsaturated monomer (b-1) having alkyl group of four to eight carbon atoms, there may be used, for instance, a product of monoesterification between (meth)acrylic acid and monohydric alcohol having an alkyl group of four to eight carbon atoms, concrete examples of which include n-butyl (meth)acrylate, iso-butyl (meth)acrylate, tert-butyl (meth)acrylate, pentyl (meth)acrylate, hexyl (meth)acrylate, octyl (meth)acrylate, 2-ethylhexyl (meth)acrylate, etc., which may be used either singly or in combination of two or more species.

In this description, “(meth)acrylate” means acrylate or methacrylate, and “(meth)acrylic acid” means acrylic acid or methacrylic acid. Likewise, “(meth)acryloyl” means acryloyl or methacryloyl, and “(meth)acryl amide” means acryl amide or methacryl amide.

For polymerizable unsaturated monomer (b-1) having alkyl group of four to eight carbon atoms, n-butyl (meth)acrylate, 2-ethylhexyl (meth)acrylate, etc., are preferably employed from the viewpoint of the distinctness-of-image gloss, water resistance, etc., of the obtained multilayered coating film.

For hydroxyl group-containing polymerizable unsaturated monomer (b-2), there may be used those having one hydroxyl group and one polymerizable double bond in a molecule, for instance, a product of monoesterification between (meth)acrylic acid and dihydric alcohol having two to eight, preferably two to four, carbon atoms, such as 2-hydroxyethyl (meth)acrylate, 2-hydroxypropyl (meth)acrylate, 3-hydroxypropyl (meth)acrylate and 4-hydroxybutyl (meth)acrylate; a product prepared by modification with ε-caprolactone of the above-mentioned product of monoesterification between (meth)acrylic acid and dihydric alcohol having two to eight carbon atoms; N-hydroxymethyl (meth)acrylamide; allyl alcohol; and (meth)acrylate having polyoxyethylene chaing whose molecular terminal is hydroxyl group, which may be used either singly or in combination of two or more species. In particular, 2-hydroxyethyl (meth)acrylate, 2-hydroxypropyl (meth)acrylate, 3-hydroxypropyl (meth)acrylate and 4-hydroxybutyl (meth)acrylate are preferably used from the viewpoint of the smoothness, distinctness-of-image gloss, water resistance, etc., of thus obtained multilayered coating film.

For carboxyl group-containing polymerizable unsaturated monomer (b-3), there may be used those having one carboxyl group and one polymerizable double bond in a molecule, for instance, (meth)acrylic acid, maleic acid, crotonic acid, β-carboxyethylacrylate, etc., which may be used either singly or in combination of two or more species. In particular, acrylic acid and methacrylic acid are preferably used from the viewpoint of the smoothness, distinctness-of-image gloss, water resistance, etc., of thus obtained multilayered coating film.

The above-mentioned other polymerizable unsaturated monomer (b-4) means polymerizable unsaturated monomer other than polymerizable unsaturated monomers (b-1) to (b-3), examples of which include alkyl (meth)acrylate which has alkyl group such as alkyl or cycloalkyl (meth)acrylate such as methyl (meth)acrylate, ethyl (meth)acrylate, n-propyl (meth)acrylate, iso-propyl (meth)acrylate, nonyl (meth)acrylate, dodecyl (meth)acrylate (lauryl (meth)acrylate), tridecyl (meth)acrylate, stearyl (meth)acrylate, isostearyl (meth)acrylate, cyclohexyl (meth)acrylate, methylcyclohexyl (meth)acrylate, t-butylcyclohexyl (meth)acrylate, cyclododecyl (meth)acrylate, isobornyl (meth)acrylate, adamantyl (meth)acrylate and tricyclodecanyl (meth)acrylate; aromatic ring-containing polymerizable unsaturated monomer such as benzyl (meth)acrylate, styrene, α-methylstyrene and vinyl toluene; alkoxysilyl group-containing polymerizable unsaturated monomer such as vinyl trimethoxysilane, vinyl triethoxysilane, vinyl tris(2-methoxyethoxy) silane, γ-(meth)acryloyloxypropyl trimethoxy silane and γ-(meth)acryloyloxypropyl triethoxy silane; perfluoroalkyl (meth)acrylate such as perfluorobutylethyl (meth)acrylate and perfluorooctylethyl (meth)acrylate; polymerizable unsaturated monomer which has fluorinated alkyl group such as fluoroolefin; polymerizable unsaturated monomer which has photopolymerizable functional group such as maleimide group; vinyl compound such as N-vinyl pyrrolidone, ethylene, butadiene, chloroprene, vinyl propionate and vinyl acetate; polymerizable unsaturated monomer which has at least two polymerizable unsaturated groups in a molecule such as allyl (meth)acrylate, ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tetra(meth)acrylate, glycerol di(meth)acrylate, 1,1,1-trishydroxymethylethane di(meth)acrylate, 1,1,1-trishydroxymethylethane tri(meth)acrylate, 1,1,1-trishydroxymethylpropane tri(meth)acrylate, triallyl isocyanurate, diallyl terephthalate and divinyl benzene; nitrogen-containing polymerizable unsaturated monomer such as (meth)acrylonitrile, (meth)acrylamide, N,N-dimethylaminoethyl (meth)acrylate, N,N-diethylaminoethyl (meth)acrylate, N,N-dimethylaminopropyl (meth)acrylamide and adduct of glycidyl (meth)acrylate with amine; epoxy group-containing polymerizable unsaturated monomer such as glycidyl (meth)acrylate, n-methyl glycidyl (meth)acrylate, 3,4-epoxycyclohexylmethyl (meth)acrylate, 3,4-epoxycyclohexylethyl (meth)acrylate, 3,4-epoxycyclohexylpropyl (meth)acrylate and allyl glycidyl ether; isocyanate group-containing polymerizable unsaturated monomer such as 2-isocyanatoethyl (meth)acrylate and m-isopropenyl-α,α-dimethylbenzylisocyanate; (meth)acrylate which has polyoxyethylene chain whose molecule is terminated with alkoxy group; and carbonyl group-containing polymerizable unsaturated monomer such as acrolein, diacetone acrylamide, diacetone methacrylamide, acetoacetoxyethyl methacrylamide, formyl styrol and vinylalkyl ketone having four to seven carbon atoms (e.g., vinylmethyl ketone, vinylethyl ketone and vinylbutyl ketone). These polymerizable unsaturated monomer may be used either singly or in combination of two or more species.

Acrylic resin (b) can be produced by copolymerization of the above-mentioned monomer component by emulsion polymerization in an aqueous medium, specifically by emulsion polymerization of the above-mentioned monomer component with polymerization initiator in the presence of a surfactant.

For the above-mentioned surfactant, anionic surfactant or nonionic surfactant is suitably employed. Said anionic surfactant includes sodium salt or ammonium salt of alkyl sulfonic acid, alkylbenzene sulfonic acid and alkylphosphoric acid. Said nonionic surfactant includes polyoxyethylene oleil ether, polyoxyethylene stearyl ether, polyoxyethylene lauryl ether, polyoxyethylene tridecyl ether, polyoxyethylene phenyl ether, polyoxyethylene nonylphenyl ether, polyoxyethylene octylphenyl ether, polyoxyethylene monolaurate, polyoxyethylene monostearate, polyoxyethylene monooleate, sobitan monolaurate, sorbitan monostearate, sorbitan trioleate and polyoxyethylene osrbitan monolaurate.

Also usable are polyoxyalkylene group-containing anionic surfactant which has, in a molecule, anionic group and polyoxyalkylene group such as polyoxyethylene group, polyoxypropylene group, etc.; and reactive anionic surfactant which has, in a molecule, anionic group and radically polymerizable unsaturated group.

The above-mentioned surfactant is used in an amount ranging normally from 0.1 to 15 mass %, in particular from 0.5 to 10 mass %, especially from 1 to 5 mass %, based on the mass of total monomers used.

The above-mentioned polymerization initiator includes organic peroxide such as benzoyl peroxide, octanoyl peroxide, lauroyl peroxide, stearoyl peroxide, cumene hydroperoxide, tert-butylperoxide, di-tert-amylperoxide, tert-butylperoxy laurate, tert-butylperoxy isopropylcarbonate, tert-butylperoxy acetate and diisopropylbenzene hydroperoxide; azo compound such as azobisisobutyronitrile, azobis(2,4-dimethylvaleronitrile), azobis(2-methylpropionitrile), azobis(2-methylbutyronitrile), 4,4′-azobis(4-cyanobutanoic acid), dimethylazobis(2-methylpropionate), azobis[2-methyl-N-(2-hydroxyethyl)propionamide] and azobis{2-methyl-N [2-(1-hydroxybutyl)]propionamide}; and persulfate such as potassium persulfate, ammonium persulfate and sodium persulfate. These polymerization initiators may be used either singly or in combination of two or more species. Where necessary, a reducing agent such as sugar, sodium formaldehyde sulfoxylate and iron complex may be added to the above-mentioned polymerization initiator to make a redox initiator.

The above-mentioned polymerization initiator is used in an amount ranging normally from 0.05 to 5 mass %, in particular from 0.1 to 3 mass %, based on the mass of total monomers used. The above-mentioned polymerization initiator may be added in any means without particular limitation, depending on the species or amount of the same. For example, polymerization initiator may be contained previously in monomer component or aqueous medium, or may be added either collectively or dropwise at the time of polymerization.

The above-mentioned monomer component may contain, where necessary, component such as chain-transfer agent. The monomer component, as it is, may be added dropwise. It is preferable, however, to disperse the monomer component in an aqueous medium, and then to add thus obtained monomer emulsion dropwise. In that case, the particle size of monomer emulsion is not limited in particular.

Thus produced aqueous acrylic resin (b) may have an average particle size ranging usually from about 10 to about 1000 nm, in particular from about 15 to about 750 nm, especially from about 20 to about 500 nm.

In this description, the average particle size of aqueous acrylic resin (b) is measured with Submicron Particle Size Analyzer at 20° C. after diluted with deionized water by a normal method. For Submicron Particle Size Analyzer, “COULTER N4” (trademark; manufactured by Beckman Coulter) is usable.

In order that layer mixture between the first aqueous base coating composition (A) and the second aqueous base coating composition (B) which is mentioned later may be kept under control and that a multilayered coating film which is excellent in smoothness, distinctness-of-image gloss, chipping resistance and hardness may be formed, polymerizable unsaturated monomer (b-1) having alkyl group of four to eight carbon atoms, hydroxyl group-containing polymerizable unsaturated monomer (b-2), carboxyl group-containing polymerizable unsaturated monomer (b-3) and other polymerizable unsaturated monomer (b-4) may desirably be used in the following proportion, based on the total mass of monomers.

Polymerizable unsaturated monomer (b-1) having alkyl group of four to eight carbon atoms: 45-80% by mass, desirably 50-75% by mass, more desirably 55-70% by mass;

Hydroxyl group-containing polymerizable unsaturated monomer (b-2): 1-10% by mass, desirably 2-9% by mass, more desirably 4-8% by mass;

Carboxyl group-containing polymerizable unsaturated monomer (b-3): 1-10% by mass, desirably 1-8% by mass, more desirably 1-6% by mass; and

Other polymerizable unsaturated monomer (b-4): 0-53% by mass, desirably 8-47% by mass, more desirably 10-46% by mass.

From the viewpoint of storage stability and also of the water resistance etc., of the obtained multilayered coating film, aqueous acrylic resin (b) desirably has a hydroxyl value generally in the range of 4.5-50 mgKOH/g, in particular of 9-43 mgKOH/g, especially of 10-40 mgKOH/g.

From the viewpoint of the smoothness, distinctness-of-image gloss, chipping resistance, water resistance, etc., of the obtained multilayered coating film, aqueous acrylic resin (b) desirably has an acid value generally in the range of 7-75 mgKOH/g, in particular of 7.5-60 mgKOH/g, especially of 10-50 mgKOH/g.

Further from the viewpoint of the smoothness, water resistance, etc., of thus obtained multilayered coating film, aqueous acrylic resin (b) desirably has a weight average molecular weight generally in the range of 2,000-5,000,000, in particular of 3,000-3,000,000, especially of 5,000-2,000,000.

Aqueous Urethane Resin (c)

Aqueous urethane resin (c) means polyurethane resin which can be dispersed in an aqueous medium which comprises water either as a main solvent or as a main dispersion medium. In an aqueous medium, aqueous urethane resin (c) may take the form of aqueous solution type, colloidal dispersion type, emulsion type or slurry type, among which colloidal dispersion type and emulsion type are desirable.

For aqueous urethane resin (c), any known ones are usable. For example, polyurethane which is obtained by a reaction between polyol such as polyester polyol, polycarbonate polyol and polyether polyol and polyisocyanate may be suitably subjected to chain extension where necessary, in the presence of a chain extender which is a low molecular compound having at least two active hydrogens in a molecule, such as diol and diamine. Thus obtained aqueous urethane resin is preferably used as aqueous urethane resin (c). The same may be stably dispersed or dissolved in an aqueous medium for use.

The above-mentioned polyester polyol which is used for the production of aqueous urethane resin (c) includes polyester diol which is obtained from a reaction between aliphatic diol such as 1,4-butane diol and 1,6-hexane diol and aliphatic dicarboxylic acid such as adipic acid and sebacic acid; and polyester diol which is obtained from a reaction between said aliphatic diol and aromatic dicarboxylic acid such as terephthalic acid. Polycarbonate polyol includes polycarbonate diol which is obtained from a reaction between diol such as 1,6-hexane diol and 3-methyl-1,5-pentane diol and carbonate such as dimethyl carbonate. Polyether polyol includes polyalkylene glycol which is obtained by the ring-opening polymerization of ethylene oxide, propylene oxide, etc.

Since aqueous urethane resin (c) is to be dispersed in an aqueous medium as mentioned above, carboxyl group-containing diol is preferably used for a part of the above-mentioned polyol, and, furthermore, a carboxyl group-neutralizing agent is desirably employed as a component where necessary. Said carboxyl group-containing diol includes dimethylol propionic acid, dimethylol butanoic acid, dimethylol butyric acid and dimethylol valeric acid. For the above-mentioned carboxyl group-neutralizing agent, any basic compound is usable without limitation so long the same reacts with carboxyl group of the above-mentioned carboxyl group-containing diol to form hydrophilic salt. Specifically, tertiary amine compound such as triethyl amine and 2-(dimethylamino)ethanol, and ammonia can be mentioned, among which tertiary amine compound is preferable from the viewpoint of dispersion stability of aqueous urethane resin (c) as obtained.

The above-mentioned polyisocyanate includes aliphatic or alicyclic diisocyanate such as hexamethylene diisocyanate, dicyclohexylmethane diisocyanate, isophorone diisocyanate and hydrogenated xylylene diisocyanate, and isocyanurate ring adduct of the same.

Diol as a chain extender includes ethylene glycol, 1,4-butane diol, 1,5-pentane diol, 3-methyl-1,5-pentanediol and cyclohexane diol. Diamine includes ethylene diamine, propylene diamine and xylylene diamine.

Melamine Resin (d)

Melamine resin (d) includes methylol melamine such as dimethylol melamine, trimethylol melamine, tetramethylol melamine, pentamethylol melamine and hexamethylol melamine; alkylether compound made from methylol melamine and alcohol; and compound made from etherification between a condensate of methylol melamine and alcohol. Said alcohol includes C₁₋₁₀-alkanol such as methyl alcohol, ethyl alcohol, propyl alcohol, isopropyl alcohol, butyl alcohol, isobutyl alcohol and 2-ethylhexyl alcohol.

For melamine resin (d), melamine resin which has, on average, at least three methyl-etherified methylol groups per triazine nucleus; and hydrophilic imino group-containing alkyl etherified melamine resin having a weight average molecular weight of about 500 to about 1000 are suitably employed.

For melamine resin (d), commercial products can be employed, examples of which include “CYMEL 303”, “CYMEL 323”, “CYMEL 325”, “CYMEL 327”, CYMEL 350”, “CYMEL 370”, “CYMEL 380”, “CYMEL 385”, “CYMEL 212”, “CYMEL 253” and “CYMEL 254” (trademarks; manufactured by Japan Cytec Industries Co., Ltd.); “Rejimin 735”, “Rejimin 740”, “Rejimin 741”, “Rejimin 745”, “Rejimin 746” and “Rejimin 747” (trademarks; manufactured by Monsanto Co., Ltd.); “Sumimaru M55”, “Sumimaru M30W”, “Sumimaru M50W” (trademarks; manufactured by Sumitomo Chemical Co., Ltd.); and “U-VAN 20SE” (trademark; manufactured by Mitsui Chemicals, Inc.).

Furthermore, as a curing catalyst for melamine resin, sulfonic acid such as p-toluenesulfonic acid, dodecylbenzenesulfonic acid and dinonylnaphthalenesulfonic acid; neutralization salt made from said sulfonic acid and amine; and neutralization salt made from phosphoric acid ester compound and amine, are usable.

In the first aqueous base coating composition (A), aqueous polyester resin (a), aqueous acrylic resin (b), aqueous urethane resin (c) and melamine resin (d) are preferably used each in the following proportion from the viewpoint of the smoothness, distinctness-of-image gloss, chipping resistance, hardness, etc., of thus obtained multilayered coating film:

aqueous polyester resin (a): 15-35 parts by mass, preferably 20-30 parts by mass;
aqueous acrylic resin (b): 15-30 parts by mass, preferably 20-25 parts by mass;
aqueous urethane resin (c): 15-30 parts by mass, preferably 20-25 parts by mass; and
melamine resin (d): 15-35 parts by mass, preferably 20-30 parts by mass,
based on 100 parts by mass of the total solid content of these resins.

First aqueous base coating composition (A) can be prepared by the mixing of the above-mentioned aqueous polyester resin (a), aqueous acrylic resin (b), aqueous urethane resin (c) and melamine resin (d) uniformly in an aqueous solvent by a normal method for making a paint.

For the above-mentioned aqueous solvent, deionized water or a mixture of deionized water and hydrophilic organic solvent is usable. Said hydrophilic organic solvent includes propylene glycol monomethyl ether.

Where necessary, first aqueous base coating composition (A) may further contain paint additive such as pigment, curing catalyst, thickener, organic solvent, basic neutralizer, UV absorber, photostabilizer, surface conditioner, antioxidant, and silane coupling agent.

Pigment includes coloring pigment and extender pigment. Coloring pigment includes white pigment such as titanium oxide and zinc oxide; black pigment such as carbon black, acetylene black, lamp black, bone black, graphite, iron black and aniline black; yellow pigment such as yellow iron oxide, titanium yellow, chrome yellow, chromium oxide, monoazo yellow, condensed azo yellow, azomethine yellow, bismuth vanadate, benzimidazolone, isoindolinone, isoindoline, quinophthalone, benzidine yellow and permanent yellow; orange pigment such as permanent orange; red pigment such as red iron oxide, cadmium red, molybdenum red, naphthol AS azo red, anthanthrone, anthraquinonyl red, perylene maroon, quinacridone red pigment, diketopyrrolopyrrole, watching red and permanent red; violet pigment such as cobalt violet, quinacridone violet and dioxadine violet; blue pigment such as cobalt blue, prussian blue, phthalocyanine blue and threne blue; green pigment such as phthalocyanine green; and other azo pigment, phthalocyanine pigment, quinacridone pigment, isoindoline pigment, threne pigment and perylene pigment. The above-mentioned extender pigment includes barium sulfate, barium carbonate, calcium carbonate, aluminum silicate, plaster, clay, silica, white carbon, diatomite, talc, magnesium carbonate, alumina white, gloss white and mica powder.

These pigments may be used either singly or in combination of two or more species. From the viewpoint of the chipping resistance of thus obtained multilayered coating film, titanium oxide, barium sulfate and talc are preferably used.

Although different from species to species, the above-mentioned pigment is preferably used in an amount ranging normally from about 20 to about 120 parts by mass, based on 100 parts by mass of the total solid content of aqueous polyester resin (a), aqueous acrylic resin (b), aqueous urethane resin (c) and melamine resin (d) in the first aqueous base coating composition (A).

The above-mentioned curing catalyst includes organic metal compound, acid compound, base compound, etc. Said organic metal compound includes tetraisopropyl titanate, tetrabutyl titanate, lithium acetate, ferric (III) acetylacetonate, zinc 2-ethylhexanoate, copper acetate, vanadium trichloride, tin octylate, dibutyltin diacetate, dibutyltin dioctoate, dibutyltin dilaurate, dibutyltin dimaleate, tetrabutyltin, dibutyltin oxide, tetra-n-butyl-1,3-diacetyloxydistanoxane, tetra-n-propyl-1,3-diacetyloxydistanoxane and tetra-n-butyl-1,3-dilauryloxydistanoxane. In particular, organotin compounds such as tin octylate, dibutyltin diacetate, dibutyltin dilaurate and distanoxanes are preferred. Furthermore, where low temperature baking is required, dibutyltin diacetate can be favorably used. Said acid compound includes paratoluenesulfonic acid, dodecylbenzenesulfonic acid, dinonylnaphthalenesulfonic acid, dinonylnaphthalenedisulfonic acid, butylphosphoric acid and octylphosphoric acid. Amine-neutralized products of these acids are also suitably used. Said base compound includes trimethylamine, triethylamine, dimethylcyclohexylamine, N-tetramethylhexane-1,6-diamine, N-pentamethyldiethylenetriamine, 2-methyl-1,4-diazabicyclo[2,2,2]octane, etc.

These compounds which are mentioned above as curing catalyst may be used either singly or in combination of two or more species. Although different from species to species, the above-mentioned curing catalyst is preferably used in an amount ranging normally from about 0.05 to about 5 parts by mass, based on 100 parts by mass of the total solid content of aqueous polyester resin (a), aqueous acrylic resin (b), aqueous urethane resin (c) and melamine resin (d) in the first aqueous base coating composition (A).

The above-mentioned thickener includes inorganic thickener such as silicate, metal silicate, montmorillonite, organic montmorillonite, colloidal alumina, etc.; poly(acrylic acid) thickener such as sodium polyacrylate and polyacrylic acid-(meth) acrylic acid ester copolymer (products on the market include PRIMAL ASE-60 manufactured by Rohm and Haas); urethane association thickener which has urethane bond and polyether chain in a molecule and which, by the association of said urethane bonds with each other in an aqueous medium effectively shows a thickening action (products on the market include “UH-814N”, “UH-462”, “UH-420”, “UH-472” and “UH-540”: trademarks; manufactured by ADEKA K.K.), and “SN Thickener 612”, “SN Thickener 621N”, “SN Thickener 625N” and “SN Thickener 627N” (trademarks) each manufactured by San Nopco Co., Ltd.; cellulose derivative thickener such as carboxymethyl cellulose, methyl cellulose and hydroxyethyl cellulose; protein thickener such as casein, sodium caseinate and ammonium caseinate; alginic acid thickener such as sodium alginate; polyvinyl thickener such as polyvinyl alcohol, polyvinyl pyrrolidone and polyvinyl benzyl ether copolymer; polyether thickener such as pluronic polyethers, polyether dialkyl esters, polyether dialkyl ethers and polyether epoxy-modified matter; maleic anhydride copolymer thickener such as partial ester of vinyl methyl ether-maleic anhydride copolymer; and polyamide thickener such as polyamide amine salt, among which poly(acrylic acid) thickener and/or urethane association thickener are preferred, and urethane association thickener is in particular desirable. These thickeners may be used either singly or in combination of two or more species. The above-mentioned thickener are each preferably used in an amount ranging normally from about 0.1 to about 10 parts by mass, in particular from 0.5 to 8 parts by mass, especially from 1 to 5 parts by mass, based on 100 parts by mass of the total solid content of aqueous polyester resin (a), aqueous acrylic resin (b), aqueous urethane resin (c) and melamine resin (d) in the first aqueous base coating composition (A).

For the above-mentioned UV absorber, any known ones are usable, examples of which include benzotriazole absorber, triazine absorber, salycilic acid derivative absorber and benzophenone absorber. From the viewpoint of the weatherability and yellowing resistance of thus obtained multilayered coating film, the above-mentioned UV absorber is preferably used in an amount ranging normally from about 0.1 to 10 parts by mass, in particular from 0.2 to 5 parts by mass, especially from 0.3 to 2 parts by mass based on 100 parts by mass of the total solid content of aqueous polyester resin (a), aqueous acrylic resin (b), aqueous urethane resin (c) and melamine resin (d) in the first aqueous base coating composition (A).

For the above-mentioned photostabilizer, any known ones are usable, examples of which include hindered amine photostabilizer. From the viewpoint of the weatherability and yellowing resistance of thus obtained multilayered coating film, the above-mentioned photostabilizer is preferably used in an amount ranging normally from about 0.1 to 10 parts by mass, in particular from 0.2 to 5 parts by mass, especially from 0.3 to 2 parts by mass based on 100 parts by mass of the total solid content of aqueous polyester resin (a), aqueous acrylic resin (b), aqueous urethane resin (c) and melamine resin (d) in the first aqueous base coating composition (A).

First aqueous base coating composition (A) is applied onto the above-mentioned cured electrodeposition coating film by any known method such as air spray, airless spray, rotary atomizing and curtain coating. Static electricity may be applied when first aqueous base coating composition (A) is being applied. Among the above, air spray and rotary atomizing are in particular preferred.

From the viewpoint of the smoothness, distinctness-of-image gloss, chipping resistance, hardness, etc., of thus obtained multilayered coating film, first aqueous base coating composition (A) is desirably applied in such an amount as to form a coating film with a thickness of cured film of 20-35 μm, in particular 25-30 μm.

Step (2):

Uncured coating film of the first aqueous base coating composition (A) which has been formed in Step (1) is coated with a second aqueous base coating composition (B) without preheating, to form a second base coating film with a thickness of cured film of 8-18 μm.

Second Aqueous Base Coating Composition (B)

Second aqueous base coating composition (B) is generally used for the purpose of giving a good appearance to substrate. To prepare a second aqueous base coating composition (B), a resin component which comprises a base resin having crosslinkable functional group like carboxyl group and hydroxyl group, such as acrylic resin, polyester resin, alkyd resin, urethane resin and epoxy resin, and a curing agent such as polyisocyanate compound which may be blocked, melamine resin and urea formaldehyde resin, is dissolved or dispersed in an aqueous medium along with pigment and other additive to make a paint.

For the above-mentioned pigment, coloring pigment or effect pigment is usable. Coloring pigment includes titanium oxide, zinc oxide, carbon black, molybdenum red, prussian blue, cobalt blue, azo pigment, phthalocyanine pigment, quinacridone pigment, isoindoline pigment, threne (anthraquinone) pigment, perylene pigment, dioxadine pigment and diketopyrrolopyrrole pigment, which may be used either singly or in combination of two or more species. The above-mentioned effect pigment includes aluminum (including metallized aluminum), copper, zinc, brass, nickel, aluminum oxide, mica, aluminum oxide covered with either titanium oxide or iron oxide, mica covered with either titanium oxide or iron oxide, glass flake and hologram pigment, which may be used either singly or in combination of two or more species. The above-mentioned effect pigment is preferably scaly, and has suitably a longitudinal size usually ranging from 1 to 100 μm, in particular from 5 to 40 μm, and a thickness usually ranging from 0.001 to 5 μm, in particular from 0.01 to 2 μm.

Where necessary, second aqueous base coating composition (B) may further contain ordinary paint additive such as curing catalyst, thickener, UV absorber, photostabilizer, defoamer, plasticizer, organic solvent, surface conditioner and antisettling agent, each of which may be used either singly or in combination of two or more species.

Second aqueous base coating composition (B) is applied onto the uncured first base coating film by any known method such as air spray, airless spray, rotary atomizing and curtain coating. Static electricity may be applied when second aqueous base coating composition (B) is being applied. Among the above, air spray and rotary atomizing are in particular preferred.

From the viewpoint of the smoothness, distinctness-of-image gloss, etc., of thus obtained multilayered coating film, second aqueous base coating composition (B) is desirably applied in such an amount as to form a coating film with a thickness of cured film of 8-18 μm, in particular 10-15 μm. Especially when the second aqueous base coating composition (B) contains effect pigment, the above-mentioned range of application causes the effect pigment to be oriented to give a sense of good design with a feeling of glittering luster or optical interference.

After second aqueous base coating composition (B) has been applied, preheating or air blowing is preferably conducted where necessary, under heating conditions that the coating film is substantially not cured. Said preheating is preferably conducted at temperature usually of from about 40 to about 100° C., in particular of from about 50 to about 90° C., especially of from about 60 to about 80° C. Preheating is preferably conducted for a period usually of from 30 seconds to 15 minutes, in particular of from one to 10 minutes, especially of from two to five minutes.

In Step (2) of the method of this invention for forming a multilayered coating film, second aqueous base coating composition (B) is preferably applied by two-stage application from the viewpoint of the smoothness, distinctness-of-image gloss, design, etc., of thus obtained multilayered coating film.

In the lines of automobile body coating, normally the paint application work is separately conducted in zones, each with the same kind of coating composition, whereby to control such degradation in the quality of coating as caused by the scattering of coating composition and adhesion of the same to the substrate or coating film. For example, an automobile coating line is generally divided into undercoating zone, intermediate coating zone, base coating zone and clear coating zone. In each of these coating zones, the paint application is normally divided into two or more stages, with a setting time of from about 30 seconds to 3 minutes in between the stages to prevent sagging of coating composition and secure high coating quality. The coating stages in each of the zones are referred to, by the order of application, as the first stage, second stage, and so on.

The above-mentioned paint application is generally called multi-stage application. For instance, when the application is divided into two stages in the same zone, it is called two-stage application. If the application is divided into three stages, it is called three-stage application.

When a second aqueous base coating composition (B) is to be applied in base coating zone in Step (2) of the method of this invention for forming a multilayered coating film, two-stage application is preferably employed from the viewpoint of the coating appearance and application efficiency.

In the above-mentioned two-stage application, no preheating is conducted between the time when the application of first stage is over and the time when the application of second stage is started, but an interval of from about 30 seconds to 3 minutes is preferably placed.

In the above-mentioned two-stage application, the solids content of second aqueous base coating composition (B) preferably falls within a range in particular from 15-40% by mass, especially from 20-35% by mass, from the viewpoint of the feeling of luster, etc., of thus obtained multilayered coating film.

After a second base coating film has been formed by the above-mentioned two-stage application, preheating is preferably conducted where necessary, at a temperature at which the coating film is substantially not cured. Said preheating is preferably conducted at a temperature usually of from about 40 to about 100° C., in particular of from about 50 to about 90° C., especially of from about 60 to about 80° C. Preheating is preferably conducted for a period usually of from 30 seconds to 15 minutes, in particular of from one to 10 minutes, especially of from two to five minutes.

Step (3):

Uncured second base coating film which has been formed in Step (2) is further coated with a clear coating composition (C) to form a clear coating film with a thickness of cured film of 30-50 μm.

Clear Coating Composition (C)

For clear coating composition (C) which is used in the method of this invention for forming a multilayered coating film, any known thermosetting clear coating composition for automobile body coating can be employed. For said thermosetting clear coating composition, there can be mentioned organic solvent-based thermosetting coating composition, water-borne thermosetting coating composition, thermosetting powder coating composition and the like, each of which contains crosslinkable functional group-containing base resin and crosslinking agent.

The above-mentioned base resin includes acrylic resin, polyester resin, alkyd resin, urethane resin, epoxy resin, fluororesin and the like, each of which has crosslinkable functional group. Curing agent includes polyisocyanate compound, blocked polyisocyanate compound, melamine resin, urea formaldehyde resin, carboxyl group-containing compound, carboxyl group-containing resin, epoxy group-containing resin, epoxy group-containing compound, and the like.

As a combination of base resin and curing agent in clear coating composition (C), there can be mentioned carboxyl group-containing resin/epoxy group-containing resin, hydroxyl group-containing resin/polyisocyanate compound, hydroxyl group-containing resin/blocked polyisocyanate compound, and hydroxyl group-containing resin/melamine resin, among which the combinations of carboxyl group-containing resin/epoxy group-containing resin (hereinafter sometimes referred to as “acid/epoxy curing type clear coating composition”) and hydroxyl group-containing resin/melamine resin (hereinafter sometimes referred to as “melamine curing type clear coating composition”) are preferred from the viewpoint of the distinctness-of-image gloss and the hardness of the coating film.

Clear coating composition (C) may be of one-package type or of multi-package type such as two-pack urethane resin coating composition, among which one-package type coating composition is preferred from the aspect of working life.

Where necessary, clear coating composition (C) may also contain, to such an extent that transparency is not impaired, pigment, curing catalyst, curing catalyst, UV absorber, photostabilizer, surface conditioner, antioxidant, defoamer, fluidity conditioner, and the like.

Clear coating composition (C) is applied onto the second base coating film by any known method such as air spray, airless spray, rotary atomizing and curtain coating. Static electricity may be applied when clear coating composition (C) is being applied. Among the above, air spray and rotary atomizing are in particular preferred.

From the viewpoint of the smoothness, distinctness-of-image gloss, weatherability, etc., of thus obtained multilayered coating film, clear coating composition (C) is desirably applied in such an amount as to form a cured film with a thickness of 25-50 μm, in particular 35-45 μm.

Where necessary, an interval of from 1 to 60 minutes may be placed at room temperature after clear coating composition (C) has been applied.

Step (4):

In the method of this invention for forming a multilayered coating film, three layers of coating film of the uncured first base coating film, the uncured second base coating film and the uncured clear coating film which have been prepared in Steps (1) to (3) are simultaneously heated and cured.

The above-mentioned first base coating film, second base coating film and clear coating film are cured by ordinary film-baking means such as hot air heating, infrared heating, electronic heating, etc. Heating temperature preferably ranges usually from about 80 to about 160° C., in particular from about 100 to about 140° C. Heating time preferably ranges usually from about 10 to about 60 minutes, in particular from about 15 to about 40 minutes. This heating is capable of curing three layers of multilayered coating film of first base coating film, second base coating film and clear coating film simultaneously.

### EXAMPLES

In the following, this invention is explained in more detail by Examples and Comparative Examples, which do not limit the scope of this invention at all. In Examples, “parts” and “%” respectively mean “parts by mass” and “% by mass”.

First Aqueous Base Coating Composition (A):

Production of Aqueous Polyester Resin (a)

### Production Example 1

A reactor equipped with thermometer, thermostat, stirrer, reflux condenser and water separator was charged with 193 parts of hexahydrophthalic anhydride, 208 parts of isophthalic acid, 183 parts of adipic acid, 376 parts of neopentyl glycol and 122 parts of trimethylolpropane. Then, three hours were spent to raise the temperature from 160° C. to 230° C. After that, the temperature was kept at 230° C. while water formed was being distilled off with the water separator, and, thus, condensation reaction was conducted until acid value became 3 mgKOH/g or less. Then, in order that carboxyl group might be added to thus obtained product of condensation reaction, 30 parts of trimellitic anhydride was added, and the resultant mixture was made to react at 170° C. for 30 minutes. Subsequently, the mixture was cooled to 60° C. or less, and, then, 0.9 equivalent of 2-(dimethylamino) ethanol was added on the basis of acid group. After the mixture was thereby neutralized, deionized water was gradually added to give aqueous polyester resin (a1) having a hydroxyl value of 125 mgKOH/g, an acid value of 21 mgKOH/g and a number average molecular weight of 1300, a solids content of 45% and a pH of 7.5.

### Production Examples 2-7

Aqueous polyester resins (a2)-(a7) each having a hydroxyl value, an acid value and a number average molecular weight as shown in Table 1 and having a solids content of 45% and a pH of 7.5 were obtained in the same way as Production Example 1 except that the formulation of polybasic acid component (a-1) and alcohol component (a-2) was employed as given in Table 1. Aqueous polyester resins (a6) was not subjected to subsequent evaluation, since it failed to make a stable aqueous dispersion.

TABLE 1

| | | | Production Example | | | | | | | | | | | | | |
|---|---|---|---|---|---|---|---|---|---|---|---|---|---|---|---|---|
| | | | 1 | | 2 | | 3 | | 4 | | 5 | | 6 | | 7 | |
| | | | Aqueous polyester resin (a) | | | | | | | | | | | | | |
| | | | a1 | | a2 | | a3 | | a4 | | a5 | | a6 | | a7 | |
| | | | parts | number | parts | number | parts | number | parts | number | parts | number | parts | number | parts | number |
| | | | by | of | by | of | by | of | by | of | by | of | by | of | by | of |
| Formulation | | | mass | moles | mass | moles | mass | moles | mass | moles | mass | moles | mass | moles | mass | moles |
| Poly- | Aromatic | Iso- | 208 | 1.25 | 173 | 1.04 | 222 | 1.34 | 158 | 0.95 | 236 | 1.42 | 212 | 1.28 | 197 | 1.19 |
| basic | (a-1-1) | phthalic | | | | | | | | | | | | | | |
| acid | | acid | | | | | | | | | | | | | | |
| compo- | | Trimellitic | 30 | 0.16 | 30 | 0.16 | 30 | 0.16 | 31 | 0.16 | 30 | 0.16 | 16 | 0.08 | 47 | 0.24 |
| nent | | anhydride | | | | | | | | | | | | | | |
| (a-1) | Alicyclic | Hexa- | 193 | 1.25 | 160 | 1.04 | 206 | 1.34 | 147 | 0.95 | 219 | 1.42 | 197 | 1.28 | 183 | 1.19 |
| | (a-1-2) | hydro- | | | | | | | | | | | | | | |
| | | phthalic | | | | | | | | | | | | | | |
| | | anhydride | | | | | | | | | | | | | | |
| | Aliphatic | Adipic | 183 | 1.25 | 251 | 1.72 | 156 | 1.07 | 279 | 1.91 | 130 | 0.89 | 186 | 1.27 | 193 | 1.32 |
| | (a-1-3) | acid | | | | | | | | | | | | | | |

| | | | | | | | | |
|---|---|---|---|---|---|---|---|---|
| Alcohol component | Neopentyl | 376 | 380 | 375 | 382 | 373 | 392 | 365 |
| (a-2) | glycol | | | | | | | |
| | Trimethyl- | 122 | 124 | 122 | 124 | 121 | 112 | 126 |
| | olpropane | | | | | | | |

| | | | | | | | | |
|---|---|---|---|---|---|---|---|---|
| Characteristics | Hydroxyl | 125 | 126 | 124 | 127 | 124 | 126 | 120 |
| | value | | | | | | | |
| | (mgKOH/ | | | | | | | |
| | g) | | | | | | | |
| | Acid | 21 | 21 | 21 | 21 | 21 | 12 | 30 |
| | value | | | | | | | |
| | (mgKOH/ | | | | | | | |
| | g) | | | | | | | |
| | Number | 1300 | 1300 | 1300 | 1300 | 1300 | 1300 | 1300 |
| | average | | | | | | | |
| | molecular | | | | | | | |
| | weight | | | | | | | |

| | | | | | | | |
|---|---|---|---|---|---|---|---|
| Concentration (mole %) of poly- | 68 | 57 | 73 | 52 | 77 | 67 | 66 |
| basic acid having aromatic and/ | | | | | | | |
| or alicyclic ring, in the total | | | | | | | |
| polybasic acid | | | | | | | |

Production of Aqueous Acrylic Resin (b)

### Production Example 8

A reactor equipped with thermometer, thermostat, stirrer, reflux condenser, nitrogen gas introduction tube and dripping apparatus was charged with 60 parts of deionized water and 0.52 part of “Aqualon KH-10” (trademark of ammonium salt of polyoxyethylene alkyl ether sulfate, manufactured by Dai-Ichi Kogyo Seiyaku Co., Ltd.; Effective ingredient: 97%), which were mixed with stirring in a nitrogen gas flow, and, then, the temperature was raised to 80° C. Subsequently, 1% of the total amount of monomer emulsion which is mentioned below and 5 parts of 3% aqueous solution of ammonium persulphate were introduced into the reactor, and were maintained at 80° C. for 15 minutes. Then, three hours were spent to drip the rest of the monomer emulsion into the reactor kept at said temperature. After the dripping was over, the content of reactor was matured for one hour. Subsequently, the temperature was lowered to 30° C. while 40 parts of 5% aqueous solution of 2-(dimethylamino) ethanol was gradually fed into the reactor. Then, the content was discharged through a filter of 100-mesh nylon cloth to give aqueous acrylic resin (b1) as an acrylic emulsion having a hydroxyl value of 39 mgKOH/g, an acid value of 12 mgKOH/g and a solids content of 45%.

Monomer Emulsion:

Fifty parts of deionized water, 0.9 part of “Aqualon KH-10”, 10 parts of styrene, 20.5 parts of ethyl acrylate, 60 parts of n-butyl acrylate, 8 parts of 2-hydroxyethyl acrylate and 1.5 parts of acrylic acid were mixed with stirring to give monomer emulsion.

### Production Examples 9-14

Aqueous acrylic resins (b2)-(b7) each of which was an acrylic emulsion having a hydroxyl value and an acid value as shown in Table 2 and having a solids content of 45% were obtained in the same way as Production Example 8 except that the formulation of monomer was employed as given in Table 2.

### Production Example 15

A reactor equipped with thermometer, thermostat, stirrer, reflux condenser, nitrogen gas introduction tube and dripping apparatus was charged with 50 parts of propylene glycol monoethyl ether, which was mixed with stirring in a nitrogen gas flow, and, then, the temperature was raised to 85° C. Subsequently, 100 parts of the monomer mixture as shown in Table 2 and 2 parts of 2,2′-azobis(2,4-dimethylvaleronitrile) were dissolved to form a mixture, and, then, three hours were spent to drip said mixture into the reactor. After the dripping was over, the content of reactor was to matured at 85° C. for one hour. Subsequently, 0.5 part of 2,2′-azobis(2,4-dimethylvaleronitrile) and 10 parts of propylene glycol monomethyl ether were dissolved to form a solution, and, then, one hour was spent to drip said solution into the reactor. After the dripping was over, the content of reactor was matured for one hour, and, after that, the temperature was lowered to 30° C., and 10 parts of propylene glycol monomethyl ether was added. Then, the content was discharged through a filter of 100-mesh nylon cloth to give aqueous acrylic resin (b8) having a hydroxyl value of 39 mgKOH/g, an acid value of 60 mgKOH/g and a solids content of 60%.

TABLE 2

| Production Example | | 8 | 9 | 10 | 11 | 12 | 13 | 14 | 15 |
|---|---|---|---|---|---|---|---|---|---|
| Aqueous acrylic resin (b) | | b1 | b2 | b3 | b4 | b5 | b6 | b7 | b8 |
| Species | | Emulsion | Emulsion | Emulsion | Emulsion | Emulsion | Emulsion | Emulsion | Water |
| | | | | | | | | | soluble |
| Monomer | Styrene | 10 | 10 | 5 | 10 | 3.5 | 10 | 10 | 10 |
| | Ethyl acrylate | 20.5 | 35.5 | 5.5 | 40.5 | | 18.5 | 10 | 18.5 |
| | n-Butyl acrylate | 60 | 45 | 80 | 40 | 87 | 63.5 | 60 | 55.5 |
| | 2-Hydroxyethyl acrylate | 8 | 8 | 8 | 8 | 8 | 8 | 8 | 8 |
| | Acrylic acid | 1.5 | 1.5 | 1.5 | 1.5 | 1.5 | 0 | 12 | 8 |
| Charac- | Hydroxyl value (mgKOH/g) | 39 | 39 | 39 | 39 | 39 | 39 | 39 | 39 |
| teristics | Acid value (mgKOH/g) | 12 | 12 | 12 | 12 | 12 | 0 | 90 | 60 |
| Mono- | Polymerizable unsaturated | 60 | 45 | 80 | 40 | 87 | 64 | 60 | 56 |
| meric | monomer having C₄-C₈ | | | | | | | | |
| concen- | alkyl group | | | | | | | | |
| tration | Hydroxyl group-containing | 8 | 8 | 8 | 8 | 8 | 8 | 8 | 8 |
| (mass | polymerizable unsaturated | | | | | | | | |
| %) | monomer | | | | | | | | |
| | Carboxyl group-containing | 1.5 | 1.5 | 1.5 | 1.5 | 1.5 | 0 | 12 | 8 |
| | polymerizable unsaturated | | | | | | | | |
| | monomer | | | | | | | | |
| | Other polymerizable un- | 30.5 | 45.5 | 10.5 | 50.5 | 3.5 | 28.5 | 20 | 28.5 |
| | saturated monomer | | | | | | | | |

Production of First Aqueous Base Coating Composition (A)

### Production Example 16

There were mixed 28.9 parts of solution of aqueous polyester resin (a1) as obtained in Production Example 1 (resin solid content: 13 parts), 90 parts of “JR-806” (trademark of rutile titanium dioxide manufactured by Tayca Corporation,) one part of “Carbon MA-100” (trademark of carbon black manufactured by Mitsubishi Chemical Corporation) and 42.4 parts of deionized water, and the resultant mixture was treated with 2-(dimethylamino)ethanol to have a pH of 8.0. Then, the mixture was dispersed with a paint shaker for 30 minutes to give a pigment dispersion paste. In a mixing vessel, 162.3 parts of thus obtained pigment dispersion paste (aqueous polyester resin solid content: 13 parts), 26.7 parts of solution of aqueous polyester resin (a1) as obtained in Production Example 1 (resin solid content: 12 parts), 55.6 parts of aqueous acrylic resin (b1) as obtained in Production Example 8 (resin solid content: 25 parts), 67.6 parts of “U Coat UX-8100” (trademark of water based urethane resin manufactured by Sanyo Chemical Industries, Ltd.; solids content: 35%) (resin solid content: 25 parts), 31.3 parts of “Cymel 325” (trademark of melamine resin manufactured by Japan Cytec Industries Co., Ltd.) (resin solid content: 25 parts) and 65 parts of deionized water were mixed uniformly. To thus obtained mixture, “PRIMAL ASE-60” (trademark of thickener manufactured by Rohm and Haas), 2-(dimethylamino)ethanol and deionized water were added to give first aqueous base coating composition (A-1) having a pH of 8.2, a paint solids content of 47% and a Ford Cup #4 viscosity of 30 seconds at 20° C.

### Production Examples 17-42

First aqueous base coating compositions (A-2) to (A-27) were produced in the same manner as Production Example 16 except that the formulation of resins was employed as shown in Table 3 below.

TABLE 3

| Production Example | | | 16 | 17 | 18 | 19 | 20 | 21 | 22 | 23 | 24 | 25 | 26 | 27 | 28 | 29 |
|---|---|---|---|---|---|---|---|---|---|---|---|---|---|---|---|---|
| First aqueous base coating composition (A) | | | A-1 | A-2 | A-3 | A-4 | A-5 | A-6 | A-7 | A-8 | A-9 | A-10 | A-11 | A-12 | A-13 | A-14 |
| Aqueous | Name | | a1 | a1 | a1 | a1 | a1 | a1 | a1 | a2 | a3 | a1 | a1 | a1 | a1 | a1 |
| polyester | Amount | (from pigment dis- | 13 | 13 | 13 | 13 | 13 | 13 | 13 | 13 | 13 | 13 | 13 | 13 | 13 | 13 |
| resin (a) | | persion paste) | | | | | | | | | | | | | | |
| | | (of the origin different | 12 | 2 | 22 | 17 | 17 | 12 | 12 | 12 | 12 | 12 | 12 | 0 | 24 | 19 |
| | | from the above) | | | | | | | | | | | | | | |
| | | Total amount | 25 | 15 | 35 | 30 | 30 | 25 | 25 | 25 | 25 | 25 | 25 | 13 | 37 | 32 |

| | | | | | | | | | | | | | | | |
|---|---|---|---|---|---|---|---|---|---|---|---|---|---|---|---|
| Aqueous | Name | b1 | b1 | b1 | b1 | b1 | b1 | b1 | b1 | b1 | b2 | b3 | b1 | b1 | b1 |
| acrylic | Amount | 25 | 30 | 20 | 15 | 30 | 30 | 20 | 25 | 25 | 25 | 25 | 31 | 19 | 13 |
| resin (b) | | | | | | | | | | | | | | | |
| Aqueous | Amount | 25 | 30 | 20 | 30 | 15 | 30 | 20 | 25 | 25 | 25 | 25 | 31 | 19 | 30 |
| urethane | | | | | | | | | | | | | | | |
| resin (c) | | | | | | | | | | | | | | | |
| (Note 1) | | | | | | | | | | | | | | | |
| Melamine | Amount | 25 | 25 | 25 | 25 | 25 | 15 | 35 | 25 | 25 | 25 | 25 | 25 | 25 | 25 |
| resin (d) | | | | | | | | | | | | | | | |
| (Note 2) | | | | | | | | | | | | | | | |

| Production Example | | | 30 | 31 | 32 | 33 | 34 | 35 | 36 | 37 | 38 | 39 | 40 | 41 | 42 |
|---|---|---|---|---|---|---|---|---|---|---|---|---|---|---|---|
| First aqueous base coating composition (A) | | | A-15 | A-16 | A-17 | A-18 | A-19 | A-20 | A-21 | A-22 | A-23 | A-24 | A-25 | A-26 | A-27 |
| Aqueous | Name | | a1 | a1 | a1 | a1 | a1 | a4 | a5 | a7 | a1 | a1 | a1 | a1 | a1 |
| polyester | Amount | (from pigment dis- | 13 | 13 | 13 | 13 | 13 | 13 | 13 | 13 | 13 | 13 | 13 | 13 | 13 |
| resin (a) | | persion paste) | | | | | | | | | | | | | |
| | | (of the origin different | 15 | 19 | 15 | 14 | 20 | 12 | 12 | 12 | 12 | 12 | 12 | 12 | 12 |
| | | from the above) | | | | | | | | | | | | | |
| | | Total amount | 28 | 32 | 28 | 27 | 33 | 25 | 25 | 25 | 25 | 25 | 25 | 25 | 25 |
| Aqueous | | Name | b1 | b1 | b1 | b1 | b1 | b1 | b1 | b1 | b4 | b5 | b6 | b7 | b8 |
| acrylic | | Amount | 32 | 30 | 15 | 30 | 10 | 25 | 25 | 25 | 25 | 25 | 25 | 25 | 25 |
| resin (b) | | | | | | | | | | | | | | | |
| Aqueous | | Amount | 15 | 13 | 32 | 30 | 20 | 25 | 25 | 25 | 25 | 25 | 25 | 25 | 25 |
| urethane | | | | | | | | | | | | | | | |
| resin (c) | | | | | | | | | | | | | | | |
| (Note 1) | | | | | | | | | | | | | | | |
| Melamine | | Amount | 25 | 25 | 25 | 13 | 37 | 25 | 25 | 25 | 25 | 25 | 25 | 25 | 25 |
| resin (d) | | | | | | | | | | | | | | | |
| (Note 2) | | | | | | | | | | | | | | | |

(Note 1):
“U Coat UX-8100” (trademark of water based urethane resin, manufactured by Sanyo Chemical Industries, Ltd.)
(Note 2):
“Cymel 325” (trademark of melamine resin, manufactured by Japan Cytec Industries Co., Ltd.)

Preparation of Test Substrate

Alloyed hot dip galvanized steel plate was electrocoated with “Erekuron HG-350E” (trademark of thermosetting epoxy resin type cationically electrodeposition coating composition, manufactured by Kansai Paint Co., Ltd.) so that the cured film might have a thickness of 20 μm, and was then heated at 170° C. for 30 minutes. The coating composition was thereby cured to give a test substrate.

### Example 1

The above-mentioned test substrate was electrostatically coated with first aqueous base coating composition (A-1) as obtained in Production Example 16 so that the cured film might have a thickness of 27 μm, and was then left to stand still for six minutes. Subsequently, the uncured first base coating film was electrostatically coated with second aqueous base coating composition (B-1) as shown in (Note 3) below so that the cured film might have a thickness of 7 μm (the first stage), and was, with an interval of 1.5 minutes, further electrostatically coated so that the cured film might have a thickness of 7 μm (the second stage). Thus coated substrate was left to stand still for two minutes, and was then preheated at 80° C. for five minutes. Subsequently, the uncured second base coating film was electrostatically coated with clear coating composition (C-1) as shown in (Note 4) below so that the cured film might have a thickness of 40 μm. After left to stand still for seven minutes, the resultant three layers of coating film were simultaneously heated at 140° C. for 30 minutes and cured to give a test plate. Electrostatic coating was conducted with a rotary atomizing type electrostatic coating equipment.

### (Note 3) Second Aqueous Base Coating Composition (B-1):

“WBC-720H NH-700M” (trademark of silver-colored acrylic melamine resin type aqueous base coating composition for automobile top coating, manufactured by Kansai Paint Co., Ltd.)

### (Note 4) Clear Coating Composition (C-1):

“LUGA BAKE HK-4” (trademark of melamine curing type clear coating composition manufactured by Kansai Paint Co., Ltd.; Combination of base resin/curing agent: hydroxyl group-containing resin/melamine resin)

### Examples 2-13 and Comparative Examples 1-18

Test plates of Examples 2-13 and Comparative Examples 1-18 were prepared by the same manner as Example 1 except that first aqueous base coating composition (A-1) of Example 1 was replaced with those as mentioned in Table 4 below.

Evaluation Test

Test plates as obtained in the above-mentioned Examples 1-13 and Comparative Examples 1-18 were evaluated by the following method. Results are shown in Table 4 below.

(Test Method)

### Smoothness:

The smoothness of test plates was evaluated by LW values measured with “Wave Scan” (trademark, manufactured by BYK-Gardner). It is meant that, the lower the LW values are, the higher is the smoothness of coated surface.

### Distinctness-of-Image Gloss:

The distinctness-of-image gloss of test plates was evaluated by SW values measured with the above-mentioned “Wave Scan”. It is meant that, the lower the SW values are, the higher is the distinctness-of-image gloss of coated surface.

### Chipping Resistance:

Test plate was mounted on the sample holder of Gravelometer Model JA-400 (trademark of chipping resistance tester, manufactured by Suga Test Instruments Co., Ltd.). At a temperature of −20° C., 50 g of Grade 7 gravels was projected at the test plate at an angle of 90° from a distance of 55 cm with compressed air of 0.2 MPa (2.0 kgf/cm²). Thus treated test plate was then washed with water, and was dried. Subsequently, cloth-made adhesive tape (manufactured by Nichiban Co., Ltd.) was applied onto the coated surface, and, after the adhesive tape was peeled off, the degree of occurrence of scratches on the coating film was visually observed, and was evaluated according to the following criteria.

### 1 Mark:

Scratches were very small, and neither the electrocoated surface nor the basis steel plate was exposed.

### 1.5 Marks:

Scratches were small, and neither the electrocoated surface nor the basis steel plate was exposed.

### 2 Marks:

Although scratches were small, the electrocoated surface or the basis steel plate was exposed.

### 2.5 Marks:

Scratches were large, and the basis steel plate was remarkably exposed.

### 3 Marks:

Scratches were very large, and the basis steel plate was remarkably exposed.

### Pencil Hardness:

Lead of pencil was applied to the coated surface of test plate at a degree of 45° in accordance with JIS K 5600-5-4. The lead was moved forward about 10 mm at a uniform speed while kept pressed against the coated surface of test plate strongly enough, but to such an extent that the lead might not be broken. The hardness mark of the hardest pencil that caused no damage on the coating film was recorded as an indication of pencil hardness.

TABLE 4

| | | | Example | | | | | | | | | | | | |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| First aqueous | Name | | A-1 | A-2 | A-3 | A-4 | A-5 | A-6 | A-7 | A-8 | A-9 | A-10 | A-11 | A-1 | A-1 |
| base coating | Film thickness | | 27 | 27 | 27 | 27 | 27 | 27 | 27 | 27 | 27 | 27 | 27 | 20 | 35 |
| composition | | | | | | | | | | | | | | | |
| Second aqueous | Name | | B-1 | B-1 | B-1 | B-1 | B-1 | B-1 | B-1 | B-1 | B-1 | B-1 | B-1 | B-1 | B-1 |
| base coating | | | (Note 3) | | | | | | | | | | | | |
| composition | Film thickness | | 14 | 14 | 14 | 14 | 14 | 14 | 14 | 14 | 14 | 14 | 14 | 14 | 14 |
| Clear coating | Name | | C-1 | C-1 | C-1 | C-1 | C-1 | C-1 | C-1 | C-1 | C-1 | C-1 | C-1 | C-1 | C-1 |
| composition | | | (Note 4) | | | | | | | | | | | | |
| (C) | Film thickness | | 40 | 40 | 40 | 40 | 40 | 40 | 40 | 40 | 40 | 40 | 40 | 40 | 40 |
| Evaluation | Appear- | Smoothness | 6 | 8 | 4 | 8 | 4 | 8 | 5 | 5 | 8 | 8 | 6 | 8 | 4 |
| | ance | Distinct- | 15 | 13 | 18 | 15 | 18 | 12 | 17 | 18 | 14 | 15 | 15 | 12 | 18 |
| | | ness-of- | | | | | | | | | | | | | |
| | | image gloss | | | | | | | | | | | | | |

| | | | | | | | | | | | | | |
|---|---|---|---|---|---|---|---|---|---|---|---|---|---|
| Chipping resistance | 1 | 1 | 1.5 | 1 | 2 | 2.5 | 2 | 2 | 2 | 2 | 2 | 2 | 1 |
| Pencil hardness | F | F | F | F | F | F | H | F | H | H | F | H | F |

| | | | Example | | | | Comparative Example | | | | | | | | |
|---|---|---|---|---|---|---|---|---|---|---|---|---|---|---|---|
| | | | 14 | 15 | 16 | 17 | 1 | 2 | 3 | 4 | 5 | 6 | 7 | 8 | 9 |
| First aqueous | Name | | A-1 | A-1 | A-1 | A-1 | A-12 | A-13 | A-14 | A-15 | A-16 | A-17 | A-18 | A-19 | A-20 |
| base coating | Film thickness | | 27 | 27 | 27 | 27 | 27 | 27 | 27 | 27 | 27 | 27 | 27 | 27 | 27 |
| composition | | | | | | | | | | | | | | | |
| Second aqueous | Name | | B-1 | B-1 | B-1 | B-1 | B-1 | B-1 | B-1 | B-1 | B-1 | B-1 | B-1 | B-1 | B-1 |
| base coating | Film thickness | | 10 | 18 | 14 | 14 | 14 | 14 | 14 | 14 | 14 | 14 | 14 | 14 | 14 |
| composition | | | | | | | | | | | | | | | |
| Clear coating | Name | | C-1 | C-1 | C-1 | C-1 | C-1 | C-1 | C-1 | C-1 | C-1 | C-1 | C-1 | C-1 | C-1 |
| composition | Film thickness | | 40 | 40 | 30 | 50 | 40 | 40 | 40 | 40 | 40 | 40 | 40 | 40 | 40 |
| (C) | | | | | | | | | | | | | | | |
| Evaluation | Appear- | Smoothness | 8 | 5 | 8 | 4 | 14 | 8 | 7 | 12 | 7 | 14 | 15 | 6 | 5 |
| | ance | Distinct- | 12 | 17 | 18 | 13 | 15 | 27 | 23 | 22 | 25 | 16 | 12 | 30 | 22 |
| | | ness-of- | | | | | | | | | | | | | |
| | | image gloss | | | | | | | | | | | | | |

| | | | | | | | | | | | | | |
|---|---|---|---|---|---|---|---|---|---|---|---|---|---|
| Chipping resistance | 1 | 1 | 1 | 1.5 | 1.5 | 1.5 | 1.5 | 1.5 | 1.5 | 1.5 | 3 | 3 | 3 |
| Pencil hardness | F | F | F | H | F | F | F | F | F | F | B | H | B |

| | | | Comparative Example | | | | | | | | | | | | |
|---|---|---|---|---|---|---|---|---|---|---|---|---|---|---|---|
| | | | 10 | 11 | 12 | 13 | 14 | 15 | 16 | 17 | 18 | 19 | 20 | 21 | 22 |
| First aqueous | Name | | A-21 | A-22 | A-23 | A-24 | A-25 | A-26 | A-27 | A-1 | A-1 | A-1 | A-1 | A-1 | A-1 |
| base coating | Film thickness | | 27 | 27 | 27 | 27 | 27 | 27 | 27 | 15 | 40 | 27 | 27 | 27 | 27 |
| composition | | | | | | | | | | | | | | | |
| Second aqueous | Name | | B-1 | B-1 | B-1 | B-1 | B-1 | B-1 | B-1 | B-1 | B-1 | B-1 | B-1 | B-1 | B-1 |
| base coating | Film thickness | | 14 | 14 | 14 | 14 | 14 | 14 | 14 | 14 | 14 | 7 | 22 | 14 | 14 |
| composition | | | | | | | | | | | | | | | |
| Clear coating | Name | | C-1 | C-1 | C-1 | C-1 | C-1 | C-1 | C-1 | C-1 | C-1 | C-1 | C-1 | C-1 | C-1 |
| composition | Film thickness | | 40 | 40 | 40 | 40 | 40 | 40 | 40 | 40 | 40 | 40 | 40 | 25 | 55 |
| (C) | | | | | | | | | | | | | | | |
| Evaluation | Appear- | Smoothness | 14 | 7 | 14 | 7 | 14 | 11 | 10 | 15 | 5 | 14 | 7 | 16 | 14 |
| | ance | Distinct- | 16 | 26 | 18 | 17 | 22 | 23 | 23 | 15 | 29 | 18 | 23 | 23 | 23 |
| | | ness-of- | | | | | | | | | | | | | |
| | | image gloss | | | | | | | | | | | | | |

| | | | | | | | | | | | | | |
|---|---|---|---|---|---|---|---|---|---|---|---|---|---|
| Chipping resistance | 3 | 1.5 | 3 | 3 | 3 | 1.5 | 3 | 3 | 1 | 1.5 | 1 | 1 | 1 |
| Pencil hardness | H | F | H | 2B | F | F | F | H | F | F | F | B | H |

1. A method for forming a multilayered coating film which comprises:
(1) a step of coating a cured electrodeposition coating film with a first aqueous base coating composition (A) to form a first base coating film with a thickness of cured film of 20-35 μm;
(2) a step of coating the first base coating film with a second aqueous base coating composition (B) without preheating, to form a second base coating film with a thickness of cured film of 8-18 μm;
(3) a step of coating the second base coating film, after preheating, with a clear coating composition (C) to form a clear coating film with a thickness of cured film of 25-50 μm; and
(4) a step of heating and curing the first base coating film, the second base coating film and the clear coating film simultaneously to form a cured coating film,
wherein the first aqueous base coating composition (A) comprises 15-35 parts by mass of an aqueous polyester resin (a), 15-30 parts by mass of an aqueous acrylic resin (b), 15-30 parts by mass of an aqueous urethane resin (c) and 15-35 parts by mass of a melamine resin (d), based on 100 parts by mass of the total solid content of these resins, wherein aqueous polyester resin (a) is made of a polybasic acid component which comprises 55-75 mole % of aromatic ring- and/or alicyclic ring-containing polybasic acid based on the total amount of polybasic acid, aqueous polyester resin (a) having an acid value of 15-25 mgKOH/g and a number average molecular weight of 1000-5000, and
wherein aqueous acrylic resin (b) is an acrylic emulsion which is obtained from the emulsion polymerization of a monomer component which comprises 45-80% by mass of polymerizable unsaturated monomer having alkyl group of four to eight carbon atoms, 1-10% by mass of hydroxyl group-containing polymerizable unsaturated monomer, 1-10% by mass of carboxyl group-containing polymerizable unsaturated monomer and 0-53% by mass of other polymerizable unsaturated monomer, based on the total mass of the monomers.

2. The method of claim 1 for forming a multilayered coating film wherein aromatic ring-containing polybasic acid (a-1-1) is selected from the group consisting of phthalic acid, phthalic anhydride, isophthalic acid, trimellitic acid and trimellitic anhydride, and alicyclic ring-containing polybasic acid (a-1-2) is selected from the group consisting of 1,2-cyclohexanedicarboxylic acid, 1,2-cyclohexanedicarboxylic anhydride, 1,3-cyclohexanedicarboxylic acid, 1,4-cyclohexanedicarboxylic acid, cyclohex-4-ene-1,2-dicarboxylic acid and cyclohex-4-ene-1,2-dicarboxylic anhydride.

3. The method of claim 1 for forming a multilayered coating film wherein the molar ratio of aromatic ring-containing polybasic acid (a-1-1) to alicyclic ring-containing polybasic acid (a-1-2) falls within the range of from 35/65 to 0/100.

4. The method of claim 1 for forming a multilayered coating film wherein aqueous polyester resin (a) has an acid value in the range of from 18 to 23 mgKOH/g, or a number average molecular weight in the range of from 1200 to 4000.

5. The method of claim 1 for forming a multilayered coating film wherein the polymerizable unsaturated monomer having alkyl group of four to eight carbon atoms is selected from the group consisting of n-butyl (meth)acrylate and 2-ethylhexyl (meth)acrylate.

6. The method of claim 1 for forming a multilayered coating film wherein the hydroxyl group-containing polymerizable unsaturated monomer is selected from the group consisting of 2-hydroxyethyl (meth)acrylate, 2-hydroxypropyl (meth)acrylate, 3-hydroxypropyl (meth)acrylate and 4-hydroxybutyl (meth)acrylate.

7. The method of claim 1 for forming a multilayered coating film wherein the carboxyl group-containing polymerizable unsaturated monomer is selected from the group consisting of acrylic acid and methacrylic acid.

8. The method of claim 1 for forming a multilayered coating film wherein aqueous acrylic resin (b) is an acrylic emulsion which is obtained from the emulsion polymerization of a monomer component which comprises 50-75% by mass of polymerizable unsaturated monomer having alkyl group of four to eight carbon atoms, 2-9% by mass of hydroxyl group-containing polymerizable unsaturated monomer, 1-8% by mass of carboxyl group-containing polymerizable unsaturated monomer and 8-47% by mass of other polymerizable unsaturated monomer, based on the total mass of the monomers.

9. The method of claim 1 for forming a multilayered coating film wherein aqueous acrylic resin (b) has a hydroxyl value in the range of 4.5-50 mgKOH/g, an acid value in the range of 7-75 mgKOH/g, and a weight average molecular weight in the range of 2,000-5,000,000.

10. The method of claim 1 for forming a multilayered coating film wherein aqueous urethane resin (c) is a urethane resin of colloidal dispersion type or of emulsion type.

11. The method of claim 1 for forming a multilayered coating film wherein first aqueous base coating composition (A) comprises 20-30 parts by mass of aqueous polyester resin (a), 20-25 parts by mass of aqueous acrylic resin (b), 20-25 parts by mass of aqueous urethane resin (c) and 20-30 parts by mass of melamine resin (d), based on 100 parts by mass of the total solid content of these resins.

12. The method of claim 1 for forming a multilayered coating film wherein, in Step (2), second aqueous base coating composition (B) is applied by two-stage application.

13. The method of claim 1 for forming a multilayered coating film wherein clear coating composition (C) is a melamine curing type clear coating composition or an acid/epoxy curing type clear coating composition.

14. An article on which a multilayered coating film has been formed by the method which is mentioned in claim 1.

15. A first aqueous base coating composition which comprises 15-35 parts by mass of an aqueous polyester resin (a), 15-30 parts by mass of an aqueous acrylic resin (b), 15-30 parts by mass of an aqueous urethane resin (c) and 15-35 parts by mass of a melamine resin (d), based on 100 parts by mass of the total solid content of these resins,
wherein aqueous polyester resin (a) is made of a polybasic acid component which comprises 55-75 mole % of aromatic ring- and/or alicyclic ring-containing polybasic acid based on the total amount of polybasic acid, aqueous polyester resin (a) having an acid value of 15-25 mgKOH/g and a number average molecular weight of 1000-5000, and
wherein aqueous acrylic resin (b) is an acrylic emulsion which is obtained from the emulsion polymerization of a monomer component which comprises 45-80% by mass of polymerizable unsaturated monomer having alkyl group of four to eight carbon atoms, 1-10% by mass of hydroxyl group-containing polymerizable unsaturated monomer, 1-10% by mass of carboxyl group-containing polymerizable unsaturated monomer and 0-53% by mass of other polymerizable unsaturated monomer, based on the total mass of the monomers.
